(19) United States
(12) Patent Application Publication
(10) Pub. No.: US 2026/0058182 A1
(43) Pub. Date: Feb. 26, 2026

(54) ACTIVE STACK COMPRESSION CONTROL SYSTEM

(71) Applicant: FuelCell Energy, Inc., Danbury, CT (US)

(72) Inventors: Benjamin Poettgen, Danbury, CT (US); Chris Pagliaro, Danbury, CT (US); Joseph LaCourse, Danbury, CT (US)

(21) Appl. No.: 19/295,257

(22) Filed: Aug. 8, 2025

Related U.S. Application Data
(60) Provisional application No. 63/687,037, filed on Aug. 26, 2024.

(51) Int. Cl. H01M 8/248; G05D 15/01; H01M 8/04313; H01M 8/04694

(52) U.S. Cl. CPC H01M 8/248; G05D 15/01; H01M 8/04313; H01M 8/04694

(57) ABSTRACT

A fuel cell stack compression system includes a tie rod configured to extend along a length of a fuel cell stack to compress the fuel cell stack when the tie rod is subjected to a tensile force, a bellows coupled to and configured to provide the tensile force on the tie rod, a strain gauge configured to measure the strain on the tie rod or on a component coupling the tie rod to the bellows, and a controller. The controller is configured to receive strain gauge measurements from the strain gauge and control pressure in the bellows to adjust the tensile force on the tie rod.

### CROSS-REFERENCE TO RELATED APPLICATIONS

This application claims the benefit of and priority to U.S. Provisional Patent Application No. 63/687,037, filed on Aug. 26, 2024, which is incorporated by reference herein in its entirety.

### BACKGROUND

A fuel cell is a device that converts chemical energy stored in hydrocarbon fuel into electrical energy by means of an electrochemical reaction. Generally, a fuel cell comprises an anode and a cathode that are separated by an electrolyte, which conducts electrically charged ions to produce electricity. For example, in a solid oxide fuel cell (“SOFC”), a solid, gas-impervious electrolyte is sandwiched between a porous anode and a porous cathode. Oxygen is transported through the cathode to the cathode/electrolyte interface, where it is reduced to oxygen ions, which migrate through the electrolyte to the anode. At the anode, the ionic oxygen reacts with fuels such as hydrogen or methane to release electrons, which then travel back to the cathode through an external circuit to generate electric power. Solid oxide fuel cells may be operated at temperatures in the range of 500 to 1000 degrees Celsius. Molten carbonate fuel cells (“MCFCs”), in contrast, typically operate at temperatures between 600 and 700 degrees Celsius and use an electrolyte composed of a molten carbonate salt mixture suspended in a porous, chemically inert ceramic matrix. At the cathode, carbon dioxide and oxygen react to form carbonate ions, which migrate through the electrolyte to react with a source of hydrogen (e.g., a hydrocarbon fuel) to produce steam, carbon dioxide, and electrons that then pass through an external circuit before flowing to the cathode. Multiple fuel cells may be arranged in series in a stack with adjacent fuel cells separated by interconnects that provide reactant distribution passageways and provide electrical connectivity between the fuel cells.

### SUMMARY

At least one aspect of the present disclosure relates to a fuel cell stack compression system including a tie rod extending along a length of a fuel cell stack and configured to compress the fuel cell stack when the tie rod is subjected to a tensile force, a bellows coupled to and configured to provide the tensile force on the tie rod, a strain gauge configured to measure strain on the tie rod or on a component coupling the tie rod to the bellows; and a controller configured to: receive a strain measurement from the strain gauge, and control pressure in the bellows to adjust the tensile force on the tie rod based on the strain measurement.

In some embodiments, the controller is further configured to receive a stack compression set point for the fuel cell stack, determine, based on the strain measurement, an estimated stack compression of the fuel cell stack, and compare the stack compression set point to the estimated stack compression, wherein the pressure in the bellows is controlled based on the comparison. In some embodiments, determining the estimated stack compression includes correlating the strain measurement to a stack compression value in a lookup table. In some embodiments, determining the estimated stack compression includes correlating the strain measurement to a stack compression value using a correlation curve.

In some embodiments, the fuel cell stack compression system further includes a knuckle mechanism including a base plate rigidly coupled to a proximal end of the bellows and a knuckle plate rotatably coupled to the base plate, coupled to a distal end of the bellows, and coupled to the tie rod, wherein expansion of the bellows causes rotation of the knuckle plate, and rotation of the knuckle plate causes the tensile force on the tie rod. In some embodiments, a longitudinal axis of the bellows is not coaxial with a longitudinal axis of the tie rod. In some embodiments, the longitudinal axis of the bellows is perpendicular to the longitudinal axis of the tie rod. In some embodiments, the strain gauge is positioned on one of the base plate or the knuckle plate.

In some embodiments, the fuel cell stack compression system further includes a bellows rod coupled to the distal end of the bellows and extending through the proximal end of the bellows, the bellows rod coupled to the knuckle plate. In some embodiments, the fuel cell stack compression system further includes a bellows rod coupling plate coupled to the bellows rod and including a slot and a bellows pin coupled to the knuckle plate and extending into the slot to slidably couple the bellows pin to the bellows rod coupling plate. In some embodiments, the bellows pin is rotatably coupled to the knuckle plate and includes a flat surface, wherein the slot of the bellows rod coupling plate is configured to apply a force to the flat surface causing the rotation of the knuckle plate.

At least one other aspect of the present disclosure relates to a fuel cell stack assembly including a fuel cell stack including a plurality of fuel cells and defining a longitudinal stack axis extending through the plurality of fuel cells, a housing including a first compression plate at a first end of the fuel cell stack and a second compression plate at a second end of the fuel cell stack, a first tie rod coupled to the first compression plate and extending through the second compression plate, and a compression system. The compression system includes a first tie rod coupling coupled to the first tie rod, a first bellows coupled to the first tie rod coupling and configured to apply a tensile force on the first tie rod when the first bellows is pressurized, the tensile force on the first tie rod pulling the first compression plate towards the second compression plate to compress the fuel cell stack, a first strain gauge configured to measure strain on the first tie rod or on a component coupling the first tie rod to the first bellows, and a controller. The controller is configured to receive a first strain measurement from the first strain gauge and control pressure in the first bellows to adjust the tensile force on the first tie rod based on the first strain measurement.

In some embodiments, the first tie rod extends through a longitudinal channel in the fuel cell stack defined by a plurality of openings in the plurality of fuel cells.

In some embodiments, the fuel cell stack assembly further includes a second tie rod coupled to the first compression plate and extending through the second compression plate, a second tie rod coupling coupled to the second tie rod, a second bellows coupled to the second tie rod coupling and configured to apply a tensile force on the second tie rod when the second bellows is pressurized, the tensile force on the second tie rod pulling the first compression plate towards the second compression plate in cooperation with the tensile force on the first tie rod to compress the fuel cell stack, and a second strain gauge configured to measure strain on the second tie rod or on a component coupling the second tie rod to the second bellows, wherein the controller is configured to receive a second strain measurement from the second strain gauge and control pressure in the second bellows to adjust the tensile force on the second tie rod based on the second strain measurement.

In some embodiments, the fuel cell stack assembly further includes a compressed gas system including a pump configured to compress gas, a first valve configured to release a portion of the compressed gas into the first bellows, wherein the controller is configured to selectively open and close the first valve to adjust the pressure in the first bellows, and a second valve configured to release a portion of the compressed gas into the second bellows, wherein the controller is configured to selectively open and close the second valve to adjust the pressure in the second bellows.

In some embodiments, the compression system includes: a base plate rigidly coupled to a proximal end of the first bellows; and a knuckle plate rotatably coupled to the base plate, coupled to a distal end of the first bellows, and coupled to the first tie rod, the knuckle plate configured to rotate upon expansion of the first bellows, rotation of the knuckle plate causing the tensile force on the first tie rod. In some embodiments, the first strain gauge is coupled to one of the knuckle plate or the base plate, wherein the controller is configured to receive a stack compression set point for the fuel cell stack, determine, based on the first strain measurement, an estimated stack compression of the fuel cell stack, and compare the stack compression set point to the estimated stack compression, wherein the pressure in the first bellows is controlled based on the comparison.

In some embodiments, a longitudinal axis of the first bellows defined by an expansion direction of the first bellows is not coaxial with the longitudinal stack axis.

At least one other aspect of the present disclosure relates to a fuel cell stack assembly including a fuel cell stack including a plurality of fuel cells and defining a longitudinal stack axis extending through the plurality of fuel cells, a housing including a first compression plate at a first end of the fuel cell stack and a second compression plate at a second end of the fuel cell stack, a tie rod coupled to the first compression plate and extending through the second compression plate, and a compression system. The compression system includes an actuator coupled to and configured to adjust tension in the tie rod, a strain gauge configured to directly or indirectly measure the tension in the tie rod, and a controller configured to receive strain measurements from the strain gauge and to control the actuator to adjust the tension in the tie rod based on the strain measurements.

In some embodiments, the actuator is coupled to a base plate and configured to exert a first force in a first direction, the fuel cell stack assembly including a knuckle plate rotatably coupled to the base plate and coupled to the actuator and the tie rod, wherein the knuckle plate is configured to receive the first force from the actuator and to exert a tensile force on the tie rod, wherein the first force and the tensile force act in different directions.

### BRIEF DESCRIPTION OF THE DRAWINGS

FIG. 1 is a side view of a fuel cell stack assembly.

FIG. 2 is a cross-sectional side view of a fuel cell stack assembly.

FIG. 3 is a side view of a fuel cell stack assembly including active stack compression systems, according to an exemplary embodiment.

FIG. 4 is a cross-sectional side view of a fuel cell stack assembly including the active stack compression system of FIG. 3, according to an exemplary embodiment.

FIG. 5 is a cross-sectional side view of the active stack compression system of FIGS. 3 and 3, according to an exemplary embodiment.

FIG. 6 is a perspective view of a portion of the active stack compression system of FIGS. 3 and 4, according to an exemplary embodiment.

FIG. 7 is a schematic diagram of the active stack compression system of FIGS. 3 and 4, according to an exemplary embodiment.

FIG. 8 is a cross-sectional side view of a fuel cell stack assembly including an active stack compression system, according to an exemplary embodiment.

FIG. 9 is a control logic diagram of the active stack compression system of FIGS. 3, 4, and 8 according to an exemplary embodiment.

It will be recognized that the Figures are schematic representations for purposes of illustration. The Figures are provided for the purpose of illustrating one or more implementations with the explicit understanding that the Figures will not be used to limit the scope of the meaning of the claims.

### DETAILED DESCRIPTION

As discussed above, multiple fuel cells may be arranged in a stack with adjacent fuel cells separated by interconnects. The stack is typically compressed along its longitudinal axis in order to maintain seals between the reactant distribution and passageways and the fuel cells to contain the reactants in the passageways. Compression may also reduce the amount of electrical contact resistance between the cells and the interconnects, which may improve the power-producing capacity of the fuel cell stack. However, excessive compression may cause cracks to form in the fuel cells, which may reduce the functional life of the fuel cell and the stack.

As discussed above, fuel cells may be operated at temperatures exceeding 500 degrees Celsius. The fuel cells and interconnects may undergo thermal expansion as the stack reaches these temperatures. As the fuel cells and interconnects expand, the stack compression, which may be provided by, for example, a spring, may increase. Alternatively, the housing surrounding the stack and coupled to the spring may expand at a faster rate than the fuel cells, causing the compression provided by the spring to decrease. Thus, it may be necessary to account for an expected difference in thermal expansion between the stack and the housing when determining the preload in the compression system. Because it may be difficult to determine precisely how much thermal expansion will occur, the amount of compression provided when the fuel cell stack is at its operating temperature may be higher or lower than is desired or expected. Additionally, stack compression may cause creep deformation of the stack over its lifetime, resulting in permanent compaction of the stack. Electrolyte loss throughout the life of the stack may further result in shrinkage and compaction of the stack. Thus, a pre-set compression system that provides a proper amount of compression at the beginning of the lifetime of the stack may not provide adequate compression as the stack ages and shrinks. Accordingly, it may be desirable to provide a compression system that allows for active control of the compressive force on the fuel cell stack.

Further, fuel cell stacks may be relatively long in their longitudinal direction. Adding an in-line stack compression system may further increase this length, which can cause the stack to take up more space along its longitudinal axis than desired. Accordingly, it may be desirable to arrange the compression system such that the compression system is not in line with the longitudinal axis on the fuel cell stack.

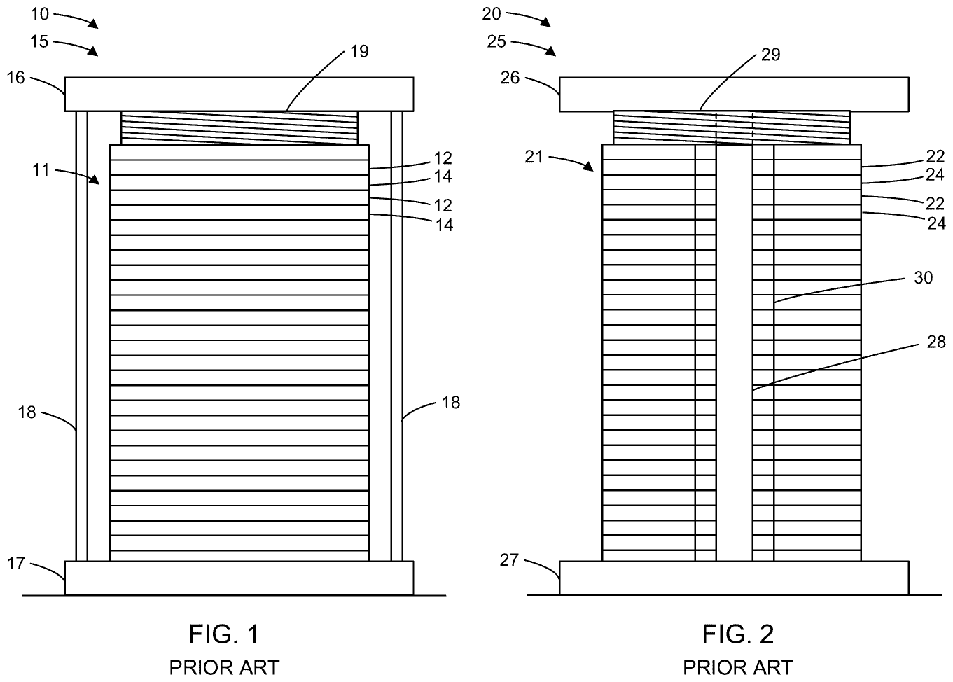

Referring to FIGS. 1 and 2, two fuel cell stack assemblies 10, 20 are shown, which include prior art compression systems that are not actively controlled. The fuel cell stack assembly 10 includes a fuel cell stack 11 positioned in a housing 15. The fuel cell stack 11 includes multiple fuel cells 12, with adjacent fuel cells 12 being separated by interconnects 14. The housing 15 includes a top plate 16 and a bottom plate 17 connected by one or more tie rods 18 positioned outside the fuel cell stack 11. For example, the fuel cells 12, interconnects 14, and plates 16, 17 may be rectangular, with four tie rods 18 positioned proximate each of the four corners of the plates 16, 17. In other embodiments, the fuel cells 12, interconnects 14, and plates 16, 17 may be different shapes (e.g., circular, annular, etc.) and the fuel cell stack assembly 10 may include any number of tie rods 18. Though not shown, the fuel cell stack assembly 10 may further include an external manifold surrounding the fuel cell stack 11. The tie rods 18 maintain a roughly fixed distance between the top plate 16 and the bottom plate 17. The fuel cell stack assembly 10 includes a compression spring 19 positioned between the top plate and the fuel cell stack 11 or between the bottom plate 17 and the fuel cell stack 11. The compression spring 19 applies a compressive force on the fuel cell stack 11, pressing the fuel cells 12 against the interconnects 14.

The fuel cell stack assembly 20 includes a fuel cell stack 21 positioned in a housing 25. The fuel cell stack 21 includes multiple fuel cells 22, with adjacent fuel cells 22 being separated by interconnects 24. The housing 25 includes a top plate 26 and a bottom plate 27. The fuel cells 22 and interconnects 24 each include an opening (e.g., an opening at the center of an annular fuel cell) that aligns with the other openings to form a longitudinal channel 30 extending through the fuel cell stack 21. A tie rod 28 may be coupled to the plates 26, 27 extending through the longitudinal channel 30. A compression spring 29 may be positioned around the tie rod 28 between the plate 26, 27 and the fuel cell stack 11, 21. The compression spring 29 may apply a compressive force on the fuel cell stack 21, pressing the fuel cells 22 against the interconnects 24. The fuel cell stack assemblies 10, 20, include tension springs rather than the compression springs 19, 29. For example, the tie rods 18, 28 may be replaced by or coupled to tension springs that couple the top plate 16, 26 to the respective bottom plate 17, 27. The tension springs thus apply a force pulling the top plate 16, 26 toward the respective bottom plate 17, 27, which compresses the respective fuel cell stack 11, 21.

In each of the fuel cell stack assemblies 10, 20, the compressive force applied by the compression springs 19, 29 to the fuel cell stack 11, 21 is determined in part based on the length of the tie rods 18, 28 and the spring rate of the compression springs 19, 29. As the fuel cell stack 11, 21 heats up and expands, the compression springs 19, 29 may be further compressed and may apply more force on the fuel cell stack 11, 21. In some embodiments, the thermal expansion rate of the tie rods 18, 28 may be greater than the thermal expansion rate of the fuel cell stack 11, 21, and the amount of force applied by the compression springs 19, 29 on the fuel cell stack 11, 21, may decrease as the fuel cell stack assembly 10, 20 heats up. In either case, changes in the operating temperature of the fuel cell stack assembly 10, 20 may cause a change in the amount of compressive force applied on the fuel cell stack 11, 21. Further, stack creep and electrolyte loss from the fuel cells 12, 22 may result in compaction of the stack 11, 21 along its longitudinal axis, reducing the compression provided by the compression springs 19, 29. If the amount of compressive force on a fuel cell stack 11, 21 is too high, the fuel cells 12, 22 may be damaged. If the amount of compressive force is too low, the electrical contact resistance between the fuel cells 12, 22 and the interconnects 14, 24 may increase, which may decrease the power-generating efficiency of the fuel cell stacks 11, 21. However, the fuel cell stack assemblies 10, 20 do not provide a means for adjusting the compressive force applied to the fuel cell stacks 11, 21 while in active operation.

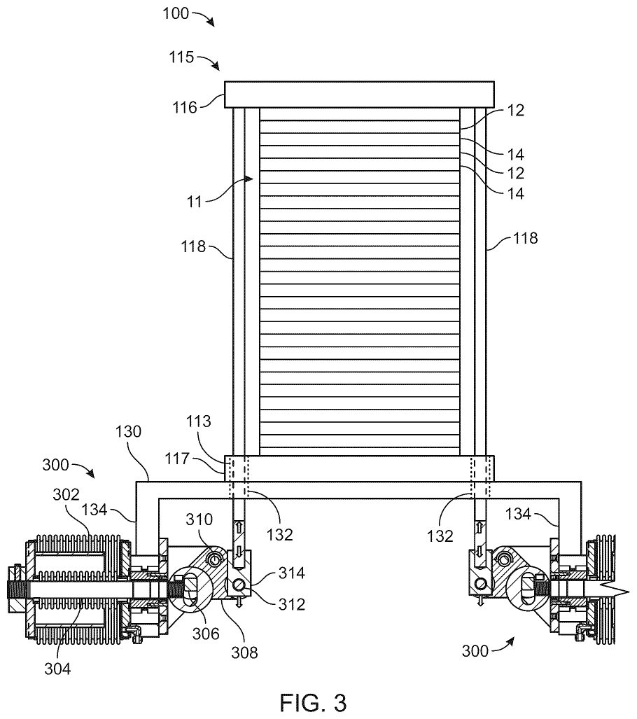

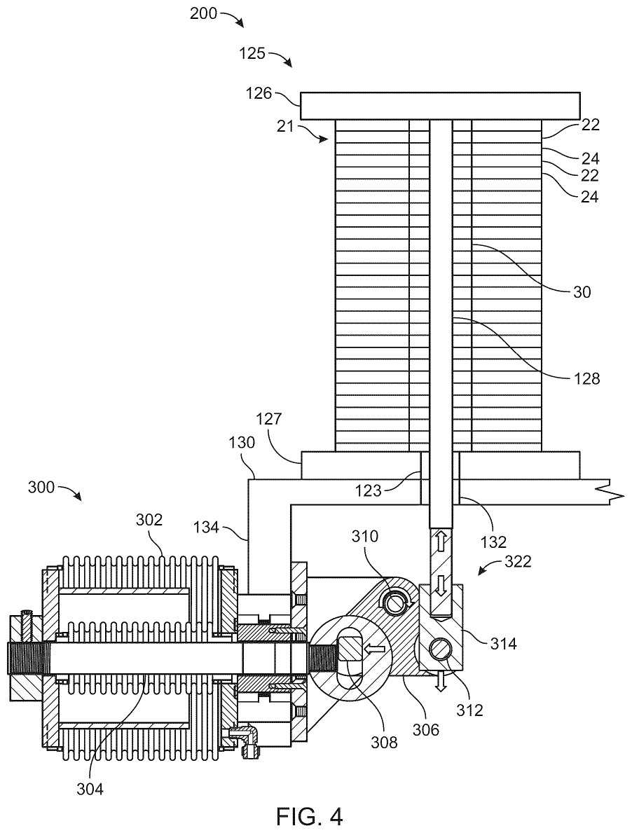

Referring now to FIGS. 3 and 4, fuel cell stack assemblies 100, 200 that utilize one or more compression systems 300 for maintaining and adjusting stack compression are shown according to some exemplary embodiments.

Fuel cell stack assembly 100 is similar to fuel cell stack assembly 10, in that the housing 115 includes tie rods 118 positioned around the outside of the fuel cell stack 11. However, rather than using a compression spring (e.g., compression spring 19) to compress the fuel cell stack 11, the fuel cell stack assembly 100 includes at least one compression system 300 configured to apply a tensile force to the tie rods 118. The tie rods 118 are coupled to a top compression plate 116 and extend through openings 113 in a bottom compression plate 117, the top and bottom compression plates 116, 117 forming a portion of a housing 115 of the fuel cell stack 11. The housing 115 is positioned on a support structure 130, which also includes openings 132 through which the tie rods 118 extend. The tie rods 118 extend along a length of the fuel cell stack 11 to compress the fuel cell stack 11 when the tie rods 118 are subjected to a tensile force.

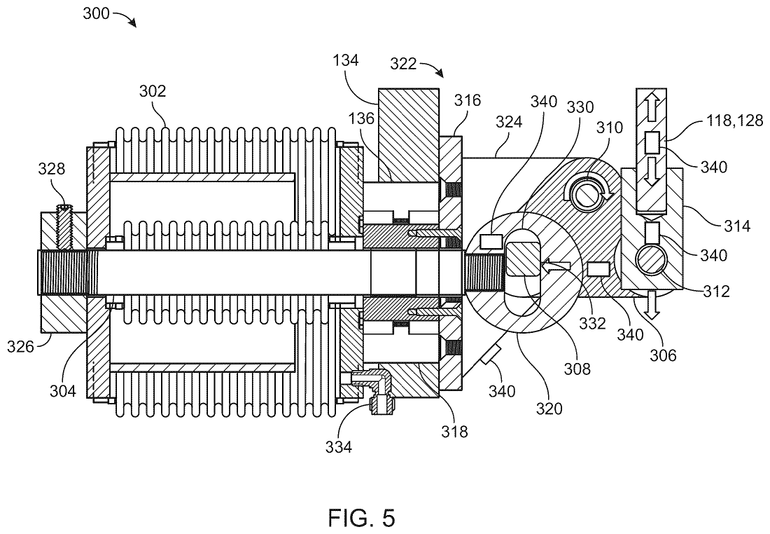

The compression system 300 is coupled to a flange 134, which may be coupled to or may be a component of the support structure 130. The compression system 300 includes a tie rod coupling 314 coupled to the tie rod 118 and configured to exert a tensile force on the tie rod 118. The tensile force on the tie rod 118 pulls the top compression plate 116 toward the bottom compression plate 117, thus exerting a compressive force on the fuel cell stack 11. The compression system 300 is shown in further detail in FIG. 5.

Fuel cell stack assembly 200 is similar to the fuel cell stack assembly 20, in that a tie rod 128 extends through a longitudinal channel 30 extending through the fuel cell stack 21. However, rather than using a compression spring (e.g., compression spring 29) to compress the fuel cell stack 21, the fuel cell stack assembly 200 includes at least one compression system 300 configured to apply a tensile force to the tie rod 128. Like the fuel cell stack assembly 200, the fuel cell stack assembly housing 125 is positioned on a support structure 130, and the tie rod 128 extends through an opening 123 in the bottom compression plate 127 and an opening 132 in the support structure 130. The tie rod 128 couples to the tie rod coupling 314, which provides a tensile force on the tie rod 128.

It should be understood that the openings 113, 123 in either of the fuel cell stack assembly 100 or the fuel cell stack assembly 200 may extend through the top compression plate 116, 126 rather than the bottom compression plate 117, 127, and the compression systems 300 may be positioned at the top of the fuel cell stack assembly 100, 200 instead of the bottom. In other embodiments, the fuel cell stack assemblies 100, 200 may be arranged in different orientations (e.g., with the stack 11 arranged sideways or at an angle, and the compression system provided at one end or the other of the stack).

Referring now to FIG. 5, the compression system 300 is shown in further detail, according to some embodiments. The compression system 300 is mounted to the flange 134 by a flange plate 316. The flange plate 316 may include or may be coupled to a through plate 318 that extends through an opening 136 in the flange 134. The compression system 300 further includes a bellows 302 coupled at a proximal end to the through plate 318. The bellows 302 are coupled to the tie rods 118, 128 and can be pressurized (e.g., inflated) to provide the tensile force on the tie rod 118, 128. Compressed gas, such as compressed air, may be provided to an inner volume of the bellows 302 via a compressed gas line 334 to pressurize the bellows. As the bellows 302 is pressurized, the bellows may expand about its longitudinal axis (e.g., right to left, as shown), and the distal (left, as shown) end of the bellows 302 may move away from the proximal (right, as shown) end or experience a force in the direction away from the proximal end.

A bellows rod 304 extends through the bellows 302 and is coupled to (e.g., threadedly coupled to) a retainer plate 326 beyond the distal end of the bellows 302. The bellows rod 304 is secured in place by a fastener such as a set screw 328 coupled to (e.g., threadedly coupled to) the retainer plate 326. The bellows rod 304 is thus coupled to the distal end of the bellows 302 (e.g., via the retainer plate 326) and extends through the bellows 302 along the longitudinal axis of the bellows 302 and through the proximal end of the bellows 302 and the flange plate 316, where it is coupled (e.g., threadedly coupled to) to a bellows rod coupling plate 320. As the bellows 302 is pressurized and expands, the distal end of the bellows 302 pushes the retainer plate 326 away from the proximal end of the bellows 302 (e.g., towards the left, as shown), thereby pushing the bellows rod 304 in the direction of the distal end of the bellows 302. In some embodiments, the bellows rod 304 may be substantially coaxial with the tie rod 118, 128, such that as the bellows 302 expands, the tension on the tie rod 118, 128 increases, increasing the compressive force on the fuel cell stack 11, 21. It should be understood that the Figures are not to scale. For example, the fuel cell stack 21 may be larger relative to the compression systems 300 than shown in FIGS. 3 and 4. Further, the bellows 302 and bellows rod 304 may be longer (e.g., horizontally, as shown) than as shown. Increasing the volume inside the bellows 302 may allow for finer control of the pressure in the bellows 302, thereby allowing for finer control of the stack compression.

In some embodiments, the compression system includes a knuckle mechanism 322, which transmits the tension force from the bellows rod 304 to the tie rod 118, 128 when the bellows rod 304 and tie rod 118, 128 are not coaxial. This may reduce the overall height of the fuel cell stack assemblies 100, 200 compared to a coaxial compression system, which may be beneficial if the fuel cell stack assemblies 100, 200 are being installed in a constrained space. The knuckle mechanism 322 includes a base plate 324 that is fixedly (e.g., rigidly) coupled to or integrally formed with the flange plate 316 and a knuckle plate 306 rotatably coupled to the base plate 324 about a rotation pin 310 (e.g., by a bearing). The bellows rod coupling plate 320 is coupled to a bellows pin 308. A distal end of the bellows 302 is coupled to the knuckle plate 306 by the bellows pin 308, such that, as the bellows 302 expands moving the bellows rod 304 in the direction of the distal end of the bellows 302 (e.g., towards the left, as shown), the bellows rod coupling plate 320 pulls the bellows pin 308 in the direction of the distal end of the bellows 302, causing the knuckle plate 306 to rotate about the rotation pin 310 (e.g., clockwise, as shown), causing the tensile force on the tie rod 118, 128. Thus, expansion of the bellows 302 causes rotation of the knuckle plate 306, and rotation of the knuckle plate 306 causes tensile force on the tie rod 118, 128. As shown in FIG. 5, the bellows pin 308 has a substantially rectangular (e.g., square) profile and is rotatably coupled to the knuckle plate 306. The bellows rod coupling plate 320 includes a slot 330 into or through which the bellows pin 308 extends to slidably couple the bellows pin 308 to the bellows rod coupling plate 320. As the knuckle plate 306 rotates, the bellows pin 308 can translate along the slot (e.g., vertically, as shown). In some embodiments, the cross-section of the bellows pin 308 may be circular or another shape. In some embodiments, the bellows pin 308 may have a substantially flat side 332 (e.g., a flat surface) to distribute the force from the bellows rod coupling plate 320. The bellows rod coupling plate 320 may thus apply a force to the flat side 332 of the bellows pin 308 to cause the rotation of the knuckle plate 306.

The knuckle mechanism 322 includes a tension pin 312 coupling the knuckle plate 306 to the tie rod coupling 314, which, as discussed above, is coupled to a tie rod 118, 128. For example, the tension pin 312 may extend into or through the tie rod coupling 314. The tension pin 312 may be rotatably coupled to one or both of the knuckle plate 306 or the tie rod coupling 314. As the bellows rod coupling plate 320 pulls the bellows pin 308 in the direction of the distal end of the bellows 302, causing the knuckle plate 306 to rotate about the rotation pin 310 (e.g., clockwise, as shown), the tension pin 312 rotates about the rotation pin 310 along with the knuckle plate 306. Due to the position of the tension pin 312 relative to the rotation pin 310 and the bellows pin 308, the tension pin 312 may move or experience force in a different direction than the bellows pin 308. For example, as shown in FIG. 5, the movement of or force on the bellows pin 308 to the left, as shown, may cause the tension pin 312 to move or experience force in the downward direction, as shown. Thus, the knuckle mechanism 322 allows the force generated by the bellows 302 about its longitudinal axis to act in a different direction than the direction of the tensile force on the tie rod 118, 128, allowing for different geometrical arrangements that may reduce the amount of space required for the fuel cell stack 11, 21 and the compression system 300 or systems 300. The longitudinal axis of the bellows 302 may thus be perpendicular to or otherwise not coaxial with the longitudinal axis of the tie rod 118, 128. The longitudinal axis of the bellows 302 may be defined by an expansion direction of the bellows 302 and may be coaxial with the longitudinal axis of the bellows rod 304.

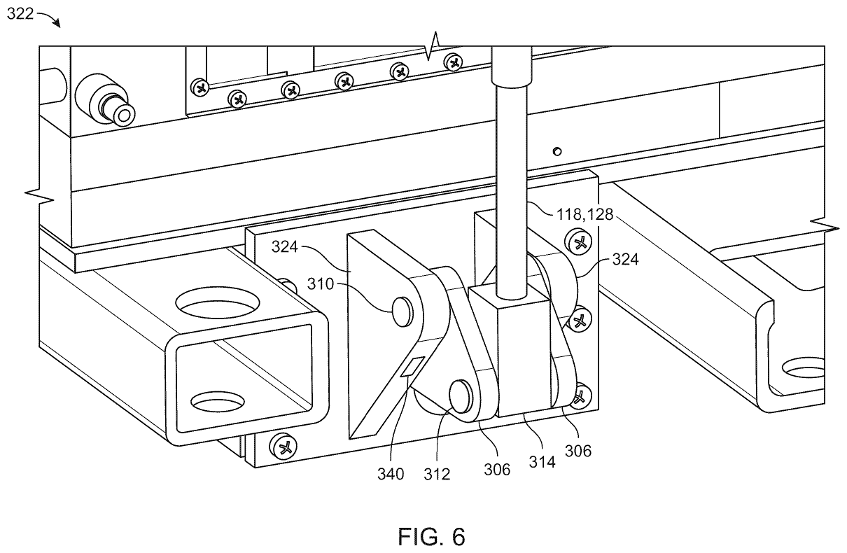

FIG. 6 shows a perspective view of the knuckle mechanism 322 according to some embodiments. As shown in FIG. 6, the knuckle mechanism 322 includes a second base plate 324 and a second knuckle plate 306 positioned on the opposite side of bellows rod coupling plate 320 and the tie rod coupling 314. Thus, the second base plate 324 and the second knuckle plate 306 may form a clevis with the base plate 324 and knuckle plate 306 that are shown in FIG. 5. The bellows pin 308 extends through the slot 330 in the bellows rod coupling plate 320 and is coupled to (e.g., rotatably coupled to) the second knuckle plate 306, similar to the coupling of the bellows pin 308 to the knuckle plate 306 shown in FIG. 5, such that the bellows pin 308 is in double shear between the two knuckle plates 306. Similarly, the tension pin 312 extends through the opening in the tie rod coupling 314 and is coupled to (e.g., rotatably coupled to) the second knuckle plate 306, similar to the coupling of the tension pin 312 to the knuckle plate 306 shown in FIG. 5, such that the tension pin 312 is in double shear between the two knuckle plates 306. The rotation pin 310 extends through each of the knuckle plates 306 and is coupled to each of the base plates 324 such that the rotation pin 310 is in double shear between the two knuckle plates 306 and the two base plates 324. The rotation pin 310 may be rotatably coupled to the pair of knuckle plates 306, the pair of base plates 324, or both.

The compression system 300 further includes one or more strain gauges 340, which can be used to determine the compression of the fuel cell stack 11, 21. The strain gauges 340 may be coupled to the compression system in various locations and configured to measure the strain on the component to which they are coupled. For example, a strain gauge 340 may be coupled to the tie rod 118, 128, to the tie rod coupling 314, to the bellows rod coupling plate 320, to a base plate 324, or to a knuckle plate 306. In the embodiment shown in FIG. 6, the knuckle mechanism 322 includes a strain gauge 340 coupled to the base plate 324. The strain in the base plate 324, or in any of the components described above, can be used to determine the compression on the fuel cell stack 11, 21. A strain gauge 340 coupled to the tie rod 118, 128 may provide the most direct measurement of the compression on the fuel cell stack 11, 21. However, in some cases, it may be impractical to position a strain gauge 340 on the tie rod 118, 128. If the strain gauge 340 is coupled to another component of the compression system 300 coupling the tie rod 118, 128 to the bellows 302, such as the base plate 324, the tension in the tie rod 118, 128 and/or the compression on the fuel cell stack 11, 21 may be indirectly derived from experimental data or from a geometrical calculation. For example, testing may be performed to determine the strains measured by a strain gauge 340 coupled to a component of the compression system 300 at known stack compression values or known tie rod tension values. The strain gauge 340 measurements and compression values may be plotted on a graph to create a correlation curve or may be stored in a lookup table representing the correlation of strain gauge 340 readings to stack compression values or tie rod tension values. Then, when the compression system 300 is in use, the strain gauge 340 measurements may be used to identify the closest value in the lookup table or fit to the curve to determine the corresponding compression on the fuel cell stacks 11, 21 or tension in the tie rod 118, 128. In some embodiments, the stack compression force may be calculated as the sum of the tension force on each of the tie rods 118, 128.

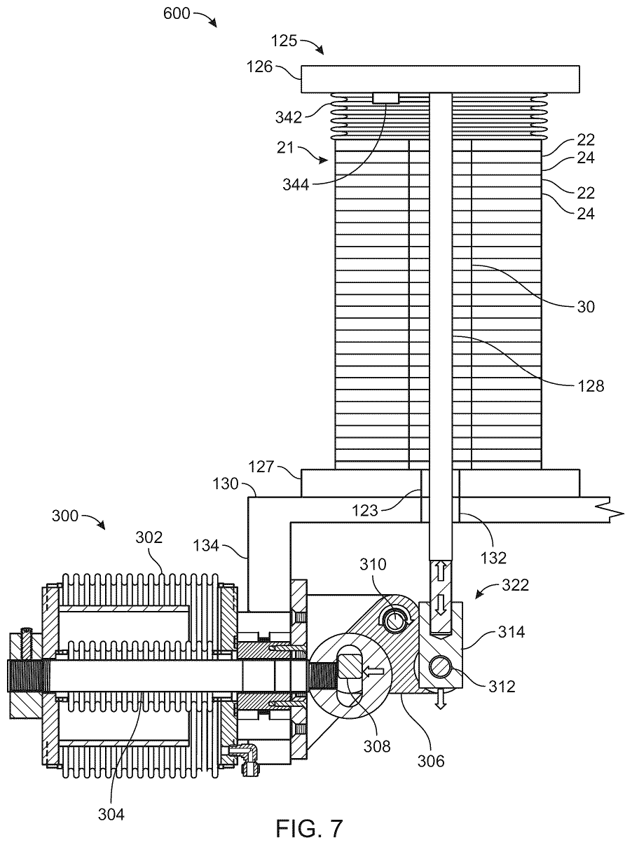

Referring now to FIG. 7, a fuel cell stack assembly 600 is shown according to an exemplary embodiment. The fuel cell stack assembly 600 may be substantially the same as the fuel cell stack assembly 200 except as shown and described herein. In particular, the compression system 300 of the fuel cell stack assembly 600 may not include strain gauges 340 but does include a second bellows 342 arranged in-line with the stack 21. The second bellows 342 may be sealed and, upon compression of the stack 21 by the compression system 300, may be compressed between the stack 21 and the top compression plate 126, causing the gas pressure inside the second bellows 342 to increase. As the pressure inside the second bellows 342 increases, the second bellows 342 may resist further compression, and the stack 21 may be compressed between the second bellows 342 and the bottom compression plate 127.

The compression system 300 may further include a pressure transducer 344 positioned in and configured to measure the pressure in the second bellows 342. Based on the pressure reading from the pressure transducer 344, the compression on the fuel cell stack 21 may be determined. For example, as discussed above regarding determining the compression of the stack 21 based on the strain measurements from the strain gauge 340, in the fuel cell stack assembly 600, the compression of the stack 21 may be indirectly derived based on the pressure measurement from experimental data or from a geometrical calculation. For example, testing may be performed to determine the pressures measured by the pressure transducer 344 at known stack compression values or known tie rod tension values. The pressure transducer 344 readings and compression values may be plotted on a graph to create a correlation curve or may be stored in a lookup table representing the correlation of pressure transducer 344 readings to stack compression values or tie rod tension values. Then, when the compression system 300 is in use, the pressure transducer 344 readings may be used to identify the closest value in the lookup table or fit to the curve to determine the corresponding compression on the fuel cell stacks 21 or tension in the tie rod 128. In some embodiments, the stack compression force may be calculated as the sum of the tension force on each of the tie rods 128. While the fuel cell stack assembly 600 is shown to be substantially similar to the fuel cell stack assembly 200, with a single tie rod 128 extending through the stack 21, it should be understood, that a compression system 300 with the second bellows 342 and the pressure transducer 344 may be incorporated into a fuel cell stack assembly similar to that of the fuel cell stack assembly 100. The second bellows 342 may similarly be positioned between the top compression plate 116 and the stack 11. In some embodiments, the second bellows 342 could instead be positioned between the stack 11, 21 and the bottom compression plate 117, 127, between the bottom compression plate 117, 127 and the support structure 130, or elsewhere in the fuel cell stack assembly.

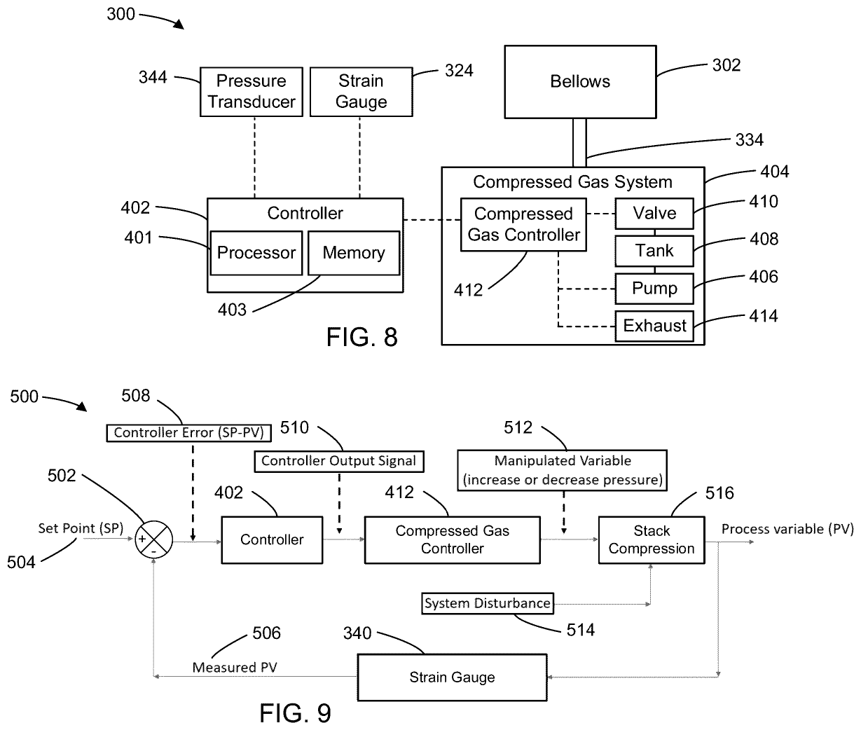

Referring now to FIG. 8, a schematic diagram of the compression system 300 is shown, according to some embodiments. The control system includes a controller 402 communicably coupled to at least one strain gauge 340 and/or at least one pressure transducer 344 in the compression system 300, as discussed above, and a compressed gas controller 412 in a compressed gas system 404. The controller 402 includes at least one memory 403 and at least one processor 401. The at least one memory 403 stores instructions that, when executed by the at least one processor 401, cause the controller 402 to perform the actions described herein. The compressed gas controller 412 may similarly include at least one memory and at least one processor. The compressed gas system 404 is configured to supply compressed gas (e.g., compressed air) to the bellows 302 of the compression system 300 via the compressed gas line 334. As shown in FIG. 8, the compressed gas system 404 includes a pump 406 configured to compress gas, a tank 408 configured to store compressed gas, and a valve 410 configured to control the flow of gas from the tank 408 to the compressed gas line 334 and the bellows 302. In some embodiments, the compressed gas system 404 may provide compressed gas to the bellows 302 using a different combination of equipment. For example, the pump 406 may directly provide pressure to the bellows 302 when activated. In some embodiments, the compressed gas system 404 may not include a compressed gas controller 412, and the controller 402 may directly control the other components of the compressed gas system 404.

In some embodiments, compression system 300 may use a type of actuator other than a bellows adjusted using compressed air. For example, a linear actuator incorporating a screw (e.g., a lead screw or ball screw) may be used to apply the force on the knuckle plate 306 to adjust the tension in the tie rods 118, 128. Turning the screw may cause the bellows pin 308 to be pulled to the left (e.g., as shown in FIG. 5) to increase the tension in the tie rod 118, 128. In other embodiments, the actuator may be a hydraulic actuator, with an increase in hydraulic pressure causing the bellows pin 308 to be pulled to the left. Regardless of the type of actuator used, compression system 300 may include the knuckle plate 306 such that, when the actuator is coupled to the base plate 324 and the knuckle plate 306 is coupled to the actuator and to the tie rod 118, 128 and is rotatably coupled to the base plate 324, the knuckle plate 306 is configured to receive the first force from the actuator and to exert a tensile force on the tie rod, with the first force and the tensile force acting in different directions (e.g., perpendicular directions). These actuators may alternatively be actuated in line with the tie rods 118, 128, such that the knuckle mechanism 322 is not required. The controller 402 may be configured to receive strain measurements from the strain gauge 340 and to control the actuator to adjust the tension in the tie rod 118, 128 based on the strain measurements.

During operation of the fuel cell stack 11, 21 the controller 402 may receive strain gauge measurements from the strain gauge 340 (and/or pressure measurements from the pressure transducer 344) and a stack compression set point, for example, via a user input or from instructions stored in the at least one memory 403. The controller 402 may determine an estimated stack compression of the fuel cell stack 11, 21 based on the strain gauge measurements (e.g., using a lookup table or correlation curve as discussed above). The controller 402 may send instructions, based on the strain gauge measurements and/or based on the estimated stack compression, to the compressed gas controller 412 to control the flow of compressed gas to the bellows 302 to adjust the pressure in the bellows 302 based on the strain measurement. For example, the controller 402 may compare the stack compression set point to the estimated stack compression and control the pressure in the bellows 302 based on the comparison. The compressed gas controller 412 may be communicably coupled to the valve 410 and may instruct the valve 410 to open to release a portion of the compressed gas into the bellows 302 through the compressed gas line 334 to increase the pressure inside the bellows 302. The compressed gas controller 412 may also be communicably coupled to the pump 406 and may activate the pump to maintain the pressure in the tank 408.

As the bellows 302 is pressurized, the controller 402 may continue to receive strain gauge data from the strain gauge 340 (and/or pressure measurements from the pressure transducer 344). When the strain gauge data indicates that the stack compression set point is reached, the controller 402 may send a signal to the compressed gas controller 412, which may instruct the valve 410 to close, such that the pressure inside the controller 402 stops increasing. In fuel cell stack assemblies 100 with multiple tie rods 118 and compression systems 300, the controller 402 may be configured to control the pressure in multiple bellows 302 to adjust the tension on tie rods 118. For example, the fuel cell stack assembly may include multiple bellows 302 with only one controller 402 and one compressed gas system 404 with a compressed gas line 334 coupled to each bellows 302. The controller 402 may control multiple valves 410 with each valve configured to release compressed air into a respective compressed gas line 334. In some embodiments, the entire system that operates to compress the fuel cell stack 11, including the multiple bellows 302 and tie rods 118 may be referred to as a compression system rather than multiple compression systems.

As shown in FIG. 8, the compressed gas system 404 includes an exhaust valve 414 configured to release pressure from the bellows 302. The compressed gas controller 412 is communicably coupled to the exhaust valve 414 and may send an instruction for the exhaust valve 414 to open when the strain gauge measurements indicate that the stack compression is above a target value, causing the pressure in the bellows 302 to decrease. The compressed gas controller 412 may send an instruction for the exhaust valve 414 to close when the strain gauge measurements indicate that the stack compression has reached the target value.

Referring now to FIG. 9, a control logic diagram 500 for the compression system 300 is shown, according to some embodiments. The control logic may be executed by the compression system 300 periodically or continuously when the fuel cell stack 11, 21 and the compression system 300 are in operation. In a first operation 502, a stack compression set point 504 and a strain gauge measurement 506 (or a pressure transducer measurement) indicating a measured or estimated stack compression are compared. The difference between the measured or estimated compression based on the strain gauge measurement 506 and the stack compression set point may be referred to as the controller error 508. Based on the controller error 508, the controller sends an output signal 510 to the compressed gas controller 412 to increase or decrease the pressure in the bellows 302, as shown in operation 512 thereby respectively increasing or decreasing the stack compression. The pressure may be increased to a target level expected to result in a target stack compression. However, due to other system variables and uncertainties, referred to in FIG. 9 as system disturbance 514, the actual stack compression 516 may not be exactly the target value expected to correlate to the target pressure value of the bellows 302. System disturbance 514 may include unexpected friction, unexpected temperature changes, deformation of components of the stack 11, 21 or components of the compression system 300, or any other factor that causes the actual stack compression 516 to deviate from the stack compression expected based on the bellows 302 pressure. Once the bellows 302 reaches the target pressure, the strain gauge 340 may provide a new measurement 506 to the controller 402, and the process can be repeated. As discussed above, the control logic may be executed by the compression system 300 periodically or continuously to account for any changes in the stack compression during the operation of the fuel cell stack 11, 21.

As utilized herein with respect to numerical ranges, the terms “approximately,” “about,” “substantially,” and similar terms generally mean+/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. In some embodiments, methods may include additional steps or may omit recited steps. Also, two or more steps may be performed concurrently or with partial concurrence, unless specified differently above.

What is claimed is:

1. A fuel cell stack compression system comprising:
a tie rod extending along a length of a fuel cell stack and configured to compress the fuel cell stack when the tie rod is subjected to a tensile force;
a bellows coupled to and configured to provide the tensile force on the tie rod;
a strain gauge configured to measure strain on the tie rod or on a component coupling the tie rod to the bellows; and
a controller configured to:
receive a strain measurement from the strain gauge; and
control pressure in the bellows to adjust the tensile force on the tie rod based on the strain measurement.

2. The fuel cell stack compression system of claim 1, wherein the controller is further configured to:
receive a stack compression set point for the fuel cell stack;
determine, based on the strain measurement, an estimated stack compression of the fuel cell stack; and
compare the stack compression set point to the estimated stack compression, wherein the pressure in the bellows is controlled based on the comparison.

3. The fuel cell stack compression system of claim 2, wherein determining the estimated stack compression comprises correlating the strain measurement to a stack compression value in a lookup table.

4. The fuel cell stack compression system of claim 2, wherein determining the estimated stack compression comprises correlating the strain measurement to a stack compression value using a correlation curve.

5. The fuel cell stack compression system of claim 1, further comprising a knuckle mechanism comprising:
a base plate rigidly coupled to a proximal end of the bellows; and
a knuckle plate rotatably coupled to the base plate, coupled to a distal end of the bellows, and coupled to the tie rod,
wherein expansion of the bellows causes rotation of the knuckle plate, and rotation of the knuckle plate causes the tensile force on the tie rod.

6. The fuel cell stack compression system of claim 5, wherein a longitudinal axis of the bellows is not coaxial with a longitudinal axis of the tie rod.

7. The fuel cell stack compression system of claim 6, wherein the longitudinal axis of the bellows is perpendicular to the longitudinal axis of the tie rod.

8. The fuel cell stack compression system of claim 5, wherein the strain gauge is positioned on one of the base plate or the knuckle plate.

9. The fuel cell stack compression system of claim 5, further comprising a bellows rod coupled to the distal end of the bellows and extending through the proximal end of the bellows, the bellows rod coupled to the knuckle plate.

10. The fuel cell stack compression system of claim 9, further comprising:
a bellows rod coupling plate coupled to the bellows rod and comprising a slot; and
a bellows pin coupled to the knuckle plate and extending into the slot to slidably couple the bellows pin to the bellows rod coupling plate.

11. The fuel cell stack compression system of claim 10, wherein the bellows pin is rotatably coupled to the knuckle plate and comprises a flat surface, wherein the slot of the bellows rod coupling plate is configured to apply a force to the flat surface causing the rotation of the knuckle plate.

12. A fuel cell stack assembly comprising:
a fuel cell stack comprising a plurality of fuel cells and defining a longitudinal stack axis extending through the plurality of fuel cells;
a housing comprising a first compression plate at a first end of the fuel cell stack and a second compression plate at a second end of the fuel cell stack;
a first tie rod coupled to the first compression plate and extending through the second compression plate; and
a compression system comprising:
a first tie rod coupling coupled to the first tie rod;
a first bellows coupled to the first tie rod coupling and configured to apply a tensile force on the first tie rod when the first bellows is pressurized, the tensile force on the first tie rod pulling the first compression plate towards the second compression plate to compress the fuel cell stack;
a first strain gauge configured to measure strain on the first tie rod or on a component coupling the first tie rod to the first bellows; and
a controller configured to:
receive a first strain measurement from the first strain gauge; and
control pressure in the first bellows to adjust the tensile force on the first tie rod based on the first strain measurement.

13. The fuel cell stack assembly of claim 12, wherein the first tie rod extends through a longitudinal channel in the fuel cell stack defined by a plurality of openings in the plurality of fuel cells.

14. The fuel cell stack assembly of claim 12, further comprising:
a second tie rod coupled to the first compression plate and extending through the second compression plate;
a second tie rod coupling coupled to the second tie rod;
a second bellows coupled to the second tie rod coupling and configured to apply a tensile force on the second tie rod when the second bellows is pressurized, the tensile force on the second tie rod pulling the first compression plate towards the second compression plate in cooperation with the tensile force on the first tie rod to compress the fuel cell stack; and
a second strain gauge configured to measure strain on the second tie rod or on a component coupling the second tie rod to the second bellows, wherein the controller is configured to:
receive a second strain measurement from the second strain gauge; and
control pressure in the second bellows to adjust the tensile force on the second tie rod based on the second strain measurement.

15. The fuel cell stack assembly of claim 14, further comprising a compressed gas system comprising:
a pump configured to compress gas;
a first valve configured to release a portion of the compressed gas into the first bellows, wherein the controller is configured to selectively open and close the first valve to adjust the pressure in the first bellows; and
a second valve configured to release a portion of the compressed gas into the second bellows, wherein the controller is configured to selectively open and close the second valve to adjust the pressure in the second bellows.

16. The fuel cell stack assembly of claim 12, wherein the compression system comprises:
a base plate rigidly coupled to a proximal end of the first bellows; and
a knuckle plate rotatably coupled to the base plate, coupled to a distal end of the first bellows, and coupled to the first tie rod, the knuckle plate configured to rotate upon expansion of the first bellows, rotation of the knuckle plate causing the tensile force on the first tie rod.

17. The fuel cell stack assembly of claim 16, wherein the first strain gauge is coupled to one of the knuckle plate or the base plate, wherein the controller is configured to:
receive a stack compression set point for the fuel cell stack;
determine, based on the first strain measurement, an estimated stack compression of the fuel cell stack; and
compare the stack compression set point to the estimated stack compression, wherein the pressure in the first bellows is controlled based on the comparison.

18. The fuel cell stack assembly of claim 12, wherein a longitudinal axis of the first bellows defined by an expansion direction of the first bellows is not coaxial with the longitudinal stack axis.

19. A fuel cell stack assembly comprising:
a fuel cell stack comprising a plurality of fuel cells and defining a longitudinal stack axis extending through the plurality of fuel cells;
a housing comprising a first compression plate at a first end of the fuel cell stack and a second compression plate at a second end of the fuel cell stack;
a tie rod coupled to the first compression plate and extending through the second compression plate; and
a compression system comprising:
an actuator coupled to and configured to adjust tension in the tie rod;
a strain gauge configured to directly or indirectly measure the tension in the tie rod; and
a controller configured to receive strain measurements from the strain gauge and to control the actuator to adjust the tension in the tie rod based on the strain measurements.

20. The fuel cell stack assembly of claim 19, wherein the actuator is coupled to a base plate and configured to exert a first force in a first direction, the fuel cell stack assembly comprising a knuckle plate rotatably coupled to the base plate and coupled to the actuator and the tie rod, wherein the knuckle plate is configured to receive the first force from the actuator and to exert a tensile force on the tie rod, wherein the first force and the tensile force act in different directions.
